(19) United States
(12) Patent Application Publication
(10) Pub. No.: US 2009/0294362 A1
(43) Pub. Date: Dec. 3, 2009

(54) STATIONARY PHASE FOR HYDROPHILIC INTERACTION CHROMATOGRAPHY

(76) Inventors: Jonas Par PERSSON, Umea (SE); Petrus Hans Hemstrom, Umea (SE); Knur Irgum, Bvllimark (SE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/130,493

(22) Filed: May 30, 2008

(51) Int. Cl. B01D 15/08

(52) U.S. Cl. 210/656; 210/198.2

(57) ABSTRACT

The present invention relates to the use of a stationary phase with neutral hydrophilic endgroups like sugar residues or polyole residues as sorbent for Hydrophilic interaction chromatography.

The present invention relates to the use of a stationary phase with neutral hydrophilic endgroups like sugar residues or polyole residues as sorbent for Hydrophilic interaction chromatography.

Hydrophilic interaction chromatography (HILIC) is a chromatographic technique that is rapidly gaining in interest. In HILIC the stationary phase is hydrophilic and the mobile phase is an organic solvent (usually 60-95% acetonitrile) with the strongly eluting member being water or an aqueous buffer. However, any water miscible aprotic solvent (e.g. THF or dioxane) can also be used. Use of alcohols is also possible; however, their concentration will need to be higher in order to achieve the same degree of retention for an analyte relative to an aprotic solvent—water combination. HILIC can also be described as “reversed-reversed phase” or “aqueous normal phase” chromatography. The development of stationary phases intended for HILIC started as late as the early 1990s, and this was also when Alpert [A. Alpert, J. Chromatogr. 1990, 499, 177-196] coined the acronym HILIC. Chromatography under HILIC conditions has, however, been routinely used since 1975 for analysis of sugars and oligosaccharides.

It is commonly believed that in HILIC, the mobile phase forms a water-rich layer on the surface of the polar stationary phase versus water-deficient mobile phase, creating a liquid/liquid extraction system. The analyte is distributed between these two layers. However, HILIC is more than just simple partitioning and includes hydrogen donor chromatography of neutral polar species as well as weak electrostatic mechanisms under the high organic solvent conditions used for retention, thus separating it as a mechanism distinct from ion exchange chromatography. The more polar compounds will have a stronger interaction with the stationary aqueous layer than the less polar compounds. Thus, a separation based on a compound's polarity and degree of solvation takes place.

A review about HILIC and its characteristics is given in Hemström, P. et al., J. Sep. Sci. 2006, 29, 1784-1821.

Ionic additives, such as ammonium acetate and ammonium formate, are usually used to control the mobile phase pH and ion strength. In HILIC they can also contribute to the polarity of the analyte, resulting in differential changes in retention.

Use of other salts such as 100-300 mM sodium perchlorate, which are soluble in high organic solvents (ca. 70% acetonitrile), is permissible for increasing the polarity of the mobile phase to effect elution, although this technique is less useful if one is relying on a mass spectrometer as a universal detector, since these salts are not volatile. Usually a gradient to increasing amounts of water suffices to promote elution.

All ions to some degree will partition into the stationary phase, so an occasional water wash will be required to assure a reproducible stationary phase is available for analytes.

As the awareness of HILIC increases, it is rapidly becoming the chemistry of choice for separation of hydrophilic substances, both charged and uncharged. Especially advantageous is the fact that there is no need for water-free solvents and that the typically used low salt acetonitrile/water eluents are directly compatible with electrospray mass spectrometry. More phases are thus being developed specifically for HILIC, to investigate the possibilities of designing special selectivities.

Presently however, commercially available columns dedicated to HILIC are, with few exceptions, either neat silica or contain some form of charged species, making them in essence mixed mode columns.

It would consequently be favorable to have a specific HILIC stationary phase that favors a pure HILIC separation mode without the interference of e.g. an ion exchange separation mode.

It has been found that an effective HILIC sorbent can be produced by grafting of neutral hydrophilic monomers, especially monomers comprising sugar or polyole residues to a solid support.

Consequently, the present invention is directed to the use of a sorbent comprising a solid support onto which neutral hydrophilic vinyl monomers have been graft-polymerized, for hydrophilic interaction chromatography (HILIC).

In a preferred embodiment, the neutral hydrophilic vinyl monomers comprise glycerol-, poly(ethyleneglycol)-, 2-hydroxypropyl-, sugar- and/or polyole residues.

In a very preferred embodiment, the neutral hydrophilic vinyl monomers comprise sorbitol, mannitol, xylite, lactate.

In another preferred embodiment, the monomers comprise methacrylate.

In another preferred embodiment, the monomers are glycerol monomethacrylate, poly(ethylene glycol)monomethylether monomethacrylate, poly(ethylene glycol)monomethacrylate, N-(2-hydroxypropyl)methacryl amide and/or sorbitolmethacrylate.

In another preferred embodiment, the solid support is made of particulate or monolithic silica.

In another preferred embodiment, the neutral hydrophilic monomers have been graft-polymerized to the solid support by a grafting-from process.

In a very preferred embodiment, the neutral hydrophilic monomers have been graft-polymerized to the solid support by a grafting-from process using a surface-bound initiator.

The present invention is also directed to a method for solid phase extraction or for separating at least two analytes by hydrophilic interaction chromatography characterized in that a sorbent is used which comprises a solid support onto which neutral hydrophilic monomers have been graft-polymerized.

In a preferred embodiment, a sorbent is used which comprises a solid support onto which neutral hydrophilic monomers have been graft-polymerized via a grafting-from process.

In another preferred embodiment, a sorbent is used which comprises a solid support onto which neutral hydrophilic monomers have been graft-polymerized which comprise glycerol-, poly(ethyleneglycol)-, 2-hydxroxypropyl-, sugar- and/or polyole residues.

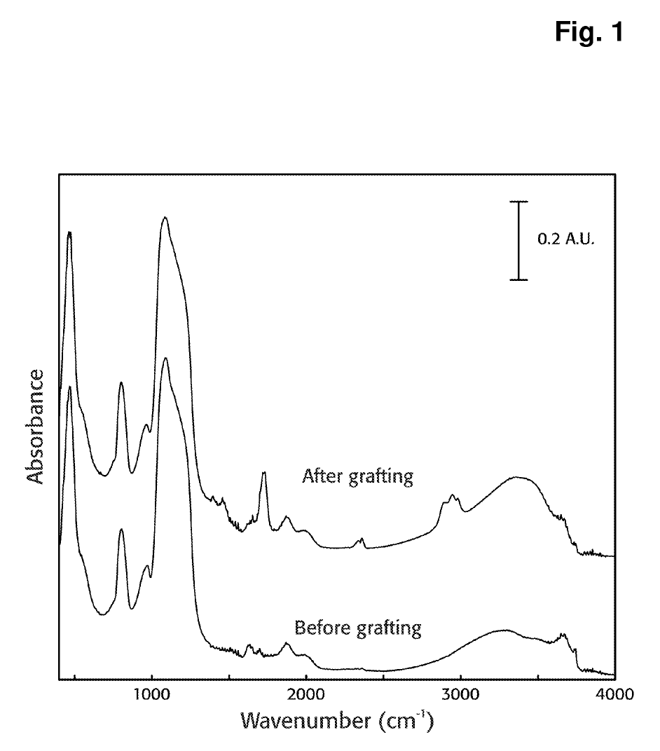

FIG. 1 shows FT-IR spectra of sorbitol methacrylate grafted silica with ungrafted Kromatsil silica (substrate) as reference. Note the carbonyl peak at 1700 cm⁻¹ and the hydroxyl hump at 3500 cm⁻¹ in the grafted silica.

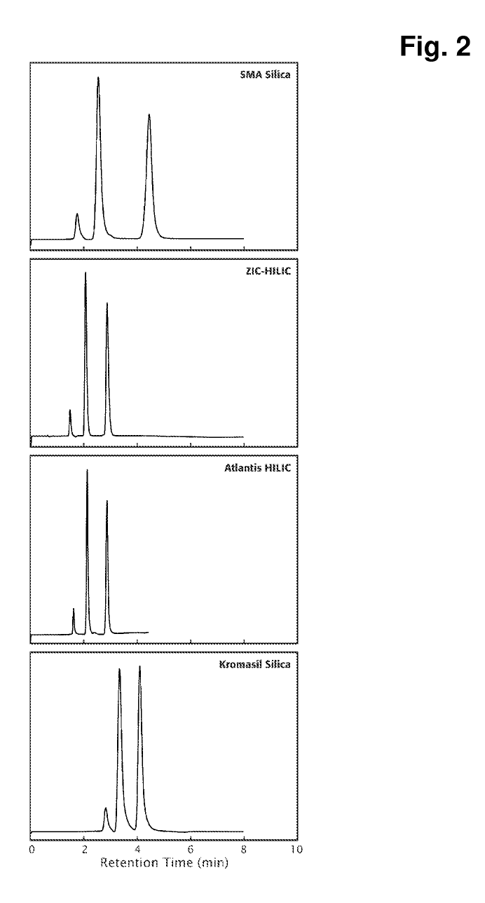

FIG. 2 shows chromatograms for the SMA HILIC and three reference columns used in HILIC for separation of toluene, uracil and cytosine. Eluent: 70% Acetonitrile/30% ammonium formate buffer, pH 4 with 25 mM buffer strength.

According to the present invention, a sorbent is any solid material that can be used as stationary phase in chromatography. The present invention especially deals with neutral sorbents or sorbents only having neutral end groups, that means sorbents that do not have any ionic groups.

A solid support is any material that can be used as base material for sorbents in chromatography. A solid support typically is a round or irregularly formed particle, a monolith or a surface layer, e.g. a coating on the inside of a capillary or the coating on a planar surface. In a preferred embodiment, the solid support is a particulate or monolithic material. The particles typically have diameters between 0.05 and 50 μm. They can be porous or non-porous. Preferably, the particles are porous with pore sizes between 50 and 500 Å in diameter.

Monolithic sorbents are sorbents that are made out of one piece. The monoliths can have every shape, like for example ashlar or cylindrical. In a preferred embodiment, the monolithic sorbents are cylindrical. To make sure that monolithic materials can be used as sorbents for chromatography, they need to have through-pores through which the eluent can flow. That means, the monolithic materials to be used in the present invention have a mono-, bi- or oligomodal pore-size distribution and comprise at least macroporous through-pores which are at least 0.1 μm in diameter. Examples for suitable monolithic materials are organic polymer monoliths disclosed by Hjerten, S. et al., J. Chromatogr. 1989, 473, 273-275 or Svec, F. et al., Anal. Chem., 1992, 64, 820-822. Preferably, inorganic or inorganic/organic hybrid monolithic materials are used as disclosed in Minakuchi, H. et al., Anal. Chem. 1996, 68, 3498-3501. Other suitable solid supports are disclosed in U.S. Pat. No. 7,025,886 (porous monoliths prepared by co-polymerization of styrene and divinylbenzene) and U.S. Pat. No. 6,804,581 or corresponding PCT/EP 2007/005096 (monodisperse polymeric beads).

Preferred monolithic materials have a bimodale pore distribution with macropores (through pores) of a diameter >0.1 μm, preferably >1 μm and mesopores with a diameter between 2 und 100 μm. Inorganic porous monolithic materials are preferably produced via a sol-gel process. In WO 95/03256 and especially in WO 98/29350 suitable processes are disclosed.

In another preferred embodiment, organic/inorganic hybrid monolithic materials are used as solid support. This can be organic/inorganic co-polymers or hybrid-materials produced via a sol-gel process as described above in which alkoxysilanes are mixed with at least 10% of one or more organoalcoxysilanes. Organoalkoxysilanes are silanes in which one to three aloxygroups is substituted by organic residues like C1 to C20 alkyl, C2 to C20 alkenyl or C5 to C20 aryl. Examples for organoalkoxysilanes are disclosed in WO 03/014450 or U.S. Pat. No. 4,017,528.

The solid support according to the present invention can be an inorganic or an organic material. Suitable organic materials are polymers like polystyrene, polyvinylalcohol, acrylates, methacrylates or polymers made of two or more different monomers. A plurality of different solid supports for chromatography is known to a person skilled in the art.

Suitable inorganic materials are SiO₂, TiO₂ or ZrO₂, preferably SiO₂.

The neutral hydrophilic vinyl monomers according to the present invention are all kinds of monomers carrying a polymerizable vinyl group. This includes vinyl and/or vinylidene groups. More specifically, the following vinyl groups may be used according to the present invention:
styrene and substituted styrene such as ring-substituted and/or side chain substituted styrenes, e.g α-chloro-styrene, α-methylstyrene, o-methyl-styrene, p-ethyl-styrene and the like;
acrylic compounds such as acrylic acid and its homologes such as methacrylic acid, and derivatives thereof such as anhydrides, amides, nitriles and the acrylic type acid esters of monohydric or polyhydric alcohols like methyl-, ethyl-, propyl-, butyl-, amyl- hexyl-alcohol or ethylene glycol, glycerol, propylene glycol etc. The most preferred acrylic compounds is methacrylic acid.
Allyl compounds such as allyl alcohols or allyl esters e.g. allyl acetate or methallylacetat,
Other vinyl or vinylidene compounds such as vinyl acetate, vinyl chloride, vinylidene chloride, vinylethylether, vinylalcohol
Unsaturated polymerizable amides or nitrites such as arylamide, methacrylamide, acrylonitrile, methacrylonitrile.

According to the present invention, the term neutral hydrophilic vinyl monomers covers one single type of vinyl monomers or a mixture of different monomers having different polymerizable groups and/or different hydrophilic neutral residues. It is also within the scope of the present invention to co-polymerize the neutral hydrophilic vinyl monomers according to the present invention with spacer monomers. Spacer monomers according to the present invention are vinyl monomers that do not have neutral hydrophilic residues but preferably lack any bulky residues. These spacer vinyl monomers without neutral hydrophilic residues are for example added to reduce steric hindrance between the neutral hydrophilic residues because they can act like a spacer between neutral hydrophilic vinyl monomers.

Hydrophilic neutral vinyl monomers according to the present invention are molecules or comprise a molecule portion that can transiently bond with water (H₂O) through hydrogen bonding. A hydrophilic molecule or portion of a molecule is one that is typically charge-polarized and capable of hydrogen bonding, enabling it to dissolve more readily in water than in oil or other hydrophobic solvents. Hydrophilic molecules are also known as polar molecules. In addition, the hydrophilic neutral monomers according to the present invention are uncharged and do not have any ionic groups.

The neutral hydrophilic portion of the hydrophilic neutral vinyl monomers according to the present invention is typically at least one sugar and/or polyole residue.

A sugar residue is any monosaccharide, disaccharide or oligosaccharide residue or a derivative of a monosaccharide, disaccharide or oligosaccharide. Examples for suitable sugar residues are glucose, fructose, saccharose, galactose, xylose, lactose, maltose, cellobiose, trehalose and ribose.

The term polyol refers to alcohols containing multiple hydroxyl groups, i.e. two or more hydroxyl groups. Examples for polyol residues are pentaerythritol, ethylene glycol, glycerin, polyethylene glycol, polypropylene glycol, poly(tetramethylene ether) glycol, maltitol, sorbit, lactate, mannitol or xylite.

A list of suitable hydrophilic neutral vinyl monomers and suitable spacer monomers is given below:
Acetoacetoxyethyl Methacrylate [21282-97-3] 7315
Acrylamide [79-06-1]
Acrylonitrile [107-13-1]
N-(Acryloxyethyl) Succinimide
Acryloyl Morpholine [05117-12-4]
Allyl Acetate [591-87-7]
Allyl Acetoacetate [111 8-84-9]
Allylacetone [109-49-9]
Allyl Alcohol [107-18-6]
1-Allyl-6-Aminouracil
Allyl Butyl Maleate [68969-35-7]
Allyl Butyrate [2051-78-7]
Allyl Cyanide [109-75-1]
Diethylene Glycol Bis(Allyl Carbonate) Diallyl
Allyl Disulfide [2179-51-9]
Allyl 2-Ethylbutyrate [7493-69-8]
N-Allyl-N′-Ethylthiourea
Allyl Glycidyl Ether [106-92-3]
Allylidenediacetate [869-29-4] 1,1-Diacetoxy-2-Propene fw 158.2 bp 184
1-Allyl Imidazole [31410-01-2] fw 108.1 bp 41 (0.1 mm)
N-Allylmorpholine [696-57-1] fw 127.2 0.93
N-Allyl-N′-(2-Hydroxyethyl) Thiourea [105-81-7] fw 160.2 mp 77-79
3-Allyloxypropionitrile [3088-44-6] fw 111.1
Allyl Propionate [2408-20-0] fw 114.1 bp 124
3-Allylsalicylaldehyde [24019-66-7]
Allyl Salicylate [10484-09-0]
1-Allyl-2-Thiourea [109-57-9]
Allylurea [557-11-9]
iso-Butyl Vinylacetate [24342-03-8]
Caprolactone Acrylate [110489-05-9]
Diacetone Acrylamide [2873-97-4]
N,N-Diethyl-N′-Allylthiourea
Diethylene Glycol Monomethacrylate [2351-43-1]
N,N-Diethylmethacrylamide [5441-99-6]
2,3-Dihydroxypropyl Acrylate [10095-20-2]
Ethoxyethoxyethyl Acrylate [7328-17-8]
Ethoxyethoxyethyl Methacrylate [45127-97-7]
2-Ethoxyethyl Acrylamide
2-Ethoxyethyl Acrylate [106-74-1]
2-Ethoxyethyl Methacrylate [2370-63-0]
Ethoxylated 2-Hydroxyethyl Methacrylate
Glyceryl Monomethacrylate [5919-74-4]
Glycidyl Acrylate [106-90-1]
Glycidyl Methacrylate [106-91-2]
2-Hydroxyethyl Acrylate [818-61-1]
N-(2-Hydroxyethyl) Methacrylamide [5238-56-2]
2-Hydroxyethyl Methacrylate [868-77-9]
N-(2-Hydroxypropyl) Methacrylamide [21442-01-3]
2-Hydroxypropyl Methacrylate [27813-02-1]
Methacrylic Anhydride [760-93-0]
Methacryloylacetone [20583-46-4]
N-(2-Methacryloyloxyethyl) Ethylene Urea
mono-(2-(Methacryloyloxy)-Ethyl) Maleate [51978-15-5]
Methallyl Acetate [820-71-3]
Methallyl Alcohol [513-42-8]
N-Methylacrylamide [1187-59-3]
Methyl 2-Acrylamido-2-Methoxyacetate [77402-03-0]
3-(4-Methylphenoxy)-2-Hydroxypropyl Methacrylate
2-N-Morpholinoethyl Acrylate [19727-38-9]
2-N-Morpholinoethyl Methacrylate [2997-88-8] 95% fw 199.3 bp 80 (0.08 mm) 1.05
N-Methylacrylamide [1187-59-3]
Methyl 2-Acrylamido-2-Methoxyacetate [77402-03-0]
Methyl Acrylamidoglycolate Methyl Ester
Methyl Tripropylene Glycol Methacrylate
2-N-Morpholinoethyl Acrylate [19727-38-9]
2-N-Morpholinoethyl Methacrylate [2997-88-8]
N-(2-Phthalimidoethoxymethyl) Acrylamide
Polyethylene Glycol 200 Monoacrylate [26403-58-7]
Polyethylene Glycol 3000 Monoacrylate [26403-58-7]
Polyethylene Glycol 3000 Monomethacrylate [25736-86-1]
Polyethylene Glycol 400 Monoacrylate [26403-58-7]
Polyethylene Glycol 8000 Monoacrylate [26403-58-7]
Polyethylene Glycol 8000 Monomethacrylate [25736-86-1]
Polyethylene Glycol 1000 Monoacrylate [26403-58-7]
Polyethylene Glycol 2000 Monoacrylate [26403-58-7]
Polyethylene Glycol 4000 Monoacrylate [26403-58-7]
Polyethylene Glycol 200 Monomethacrylate [25736-86-1]
Polyethylene Glycol 400 Monomethacrylate [25736-86-1]
Polyethylene Glycol 1000 Monomethacrylate [25736-86-1]
Polyethylene Glycol 4000 Monomethacrylate [25736-86-1]
Polypropylene Glycol 400 Monomethacrylate [39420-45-6]
Trimethylolpropane Monoallyl Ether [682-11 -1]
N-[Tris(Hydroxymethyl) Methyl] Acrylamide
N-Vinylbenzylpyrrolidone
Vinylcaprolactam [2235-00-9]
Vinylene Carbonate [872-36-6]
Vinyl 2-(2-Ethoxyethoxy) Ethyl Ether fw 160.2 bp 194
N-Vinyl Imidazole [1072-63-5]
N-(2-Vinyloxyethyl) Piperidine
Vinyl Propionate [105-38-4]
N-Vinylsuccinimide [2372-96-5]

The most preferred hydrophilic neutral vinyl monomers used in the present invention are glycerol monomethacrylate, poly(ethylene glycol)monomethylether monomethacrylate, poly(ethylene glycol)monomethacrylate and/or N-(2-hydroxypropyl)methacryl amide as well as the following monomers:
Erythrose methacrylate
Threose methacrylate
Ribose methacrylate
Arabinose methacrylate
Xylose methacrylate
Lyxose methacrylate
Ribulose methacrylate
Xylulose methacrylate
Allose methacrylate
Altrose methacrylate
Glucose methacrylate
Mannose methacrylate
Gulose methacrylate
Idose methacrylate
Galactose methacrylate
Talose methacrylate
psicose methacrylate
fructose methacrylate
sorbose methacrylate
tagatose methacrylate
Fucose methacrylate
Fuculose methacrylate
Rhamnose methacrylate
Erythrose acrylate
Threose acrylate
Ribose acrylate
Arabinose acrylate
Xylose acrylate
Lyxose acrylate
Ribulose acrylate
Xylulose acrylate
Allose acrylate
Altrose acrylate
Glucose acrylate
Mannose acrylate
Gulose acrylate
Idose acrylate
Galactose acrylate
Talose acrylate
psicose acrylate
fructose acrylate
sorbose acrylate
tagatose acrylate
Fucose acrylate
Fuculose acrylate
Rhamnose acrylate
Erythrose acrylamide
Threose acrylamide
Ribose acrylamide
Arabinose acrylamide
Xylose acrylamide
Lyxose acrylamide
Ribulose acrylamide
Xylulose acrylamide
Allose acrylamide
Altrose acrylamide
Glucose acrylamide
Mannose acrylamide
Gulose acrylamide
Idose acrylamide
Galactose acrylamide
Talose acrylamide
psicose acrylamide
fructose acrylamide
sorbose acrylamide
tagatose acrylamide
Fucose acrylamide
Fuculose acrylamide
Rhamnose acrylamide
Erythrose methacrylamide
Threose methacrylamide
Ribose methacrylamide
Arabinose methacrylamide
Xylose methacrylamide
Lyxose methacrylamide
Ribulose methacrylamide
Xylulose methacrylamide
Allose methacrylamide
Altrose methacrylamide
Glucose methacrylamide
Mannose methacrylamide
Gulose methacrylamide
Idose methacrylamide
Galactose methacrylamide
Talose methacrylamide
psicose methacrylamide
fructose methacrylamide
sorbose methacrylamide
tagatose methacrylamide
Fucose methacrylamide
Fuculose methacrylamide
Rhamnose methacrylamide
Sorbitol Acrylamide
Sorbitol Methacrylamide
Mannitol Acrylamide
Mannitol Methacrylamide
Xylitol Acrylamide
Xylitol Methacrylamide
Erythritol Acrylamide
Erythritol Methacrylamide
Maltitol Acrylamide
Maltitol Methacrylamide
Lactitol Acrylamide
Lactitol Methacrylamide
Threitol Acrylamide
Threitol Methacrylamide
Abitol Acrylate
Abitol Methacrylate
Abitol acrylamide
Abitol Methacrylamide
Sorbitol Acrylate
Sorbitol Methacrylate
Mannitol Acrylate
Mannitol Methacrylate
Xylitol Acrylate
Xylitol Methacrylate
Erythritol Acrylate
Erythritol Methacrylate
Maltitol Acrylate
Maltitol Methacrylate
Lactitol Acrylate
Lactitol Methacrylate
Threitol Acrylate
Threitol Methacrylate

The neutral hydrophilic residues of the vinyl monomers may be fully or partially protected with suitable protecting groups, for example to change the solubility of the monomers during synthesis. After the polymerization the protecting groups are removed to gain the unprotected neutral hydrophilic residues. Nevertheless, in a preferred embodiment, the monomers used for polymerization carry hydrophilic neutral residues that are not protected or otherwise modified so that no further deprotection step is needed after polymerization.

The present invention shows that grafting uncharged and highly hydrophilic vinyl monomers to a solid support, results a thick and uncharged hydrophilic interaction layer that stabilizes the adsorbed water layer on the solid support, making the HILIC system less sensitive towards small differences in eluent composition, and at the same time decreasing the ion exchange character. By grafting vinyl polymers with neutral, highly hydrophilic polyol or carbohydrate-containing side chains to porous solid support, a stationary phase with a non-charged water retaining layer results, that enables HILIC with a different chromatographic behavior, more similar to the pure partitioning of C₁₈ reversed phase stationary phases.

The grafting of monomers to a support material to form polymer chains on the solid support is well known to a person skilled in the art. It means that typically at least two or more monomers are subsequently bonded to the solid support. There are two different approaches when preparing a bonded polymeric stationary phase on a solid support. One is to use the “grafting to” method, meaning that polymer chains are first synthesized in solution and then covalently attached to the surface of the silica particle, usually by a suitable coupling agent, in case silica support materials typically silane coupling agents. However, it has been found that the “grafting to” technique is hard to use with monomers that contain a lot of hydroxyl groups, especially in combination with silica support materials, because the silylation reagents used to attach the polymers to the silanols on the silica support would also be targeting the hydroxyl groups on the polymer chains.

This can be avoided by grafting-from techniques where the monomers are one after the other directly coupled to the growing polymer chain that is anchored with its first monomer to the support material. There are numerous types of controlled grafting from polymerizations described in literature. The living ionic polymerization [Szwark, M. et al. J. Am. Chem. Soc. 1956, 78, 2656-26-57], the stable free radical polymerization (SFRP) [Geores, M. K. et al., Macromolecules, 1993, 26, 2987-2988], the reversible addition-fragmentation chain transfer (RAFT) [Chiefari, J. et al., Macromolecules, 1998, 31, 5559-5562] and the atom transfer radical polymerization (ATRP) [Wang, J. S. et al., J. Am. Chem. Soc. 1995, 117, 5614-5615, WO 98/01480, WO 96/30421 or WO 01/94424] are the most used examples. The rate of these polymerizations is controlled by trapping the growing radicals in an inactive state or by transferring them to a different polymer chain.

It is also known that synthetic carbohydrate or “glyco-” polymers can be produced by polymerizing suitable monomers. The subject has since been covered in a number of reviews the most recent being Ladmiral et al. [V. Ladmiral, E. Melia, D. M. Haddleton, Eur. Polym. J. 2004, 40, 431-449].

It has been found that for use in HILIC, it is most favorable, if multipoint attachment of the polymer chains is avoided and the polymer chains are attached at one end to the solid support.

It has further been found that this feature can favorably be accomplished if polymerization is started from a surface-bound initiator, resulting in a polymer brush attached at one end to the particle.

The stationary phase for use in HILIC is thus preferably made by a grafting-from polymerization like RAFT or most preferably ATRP, in combination with a surface-bound initiator. Suitable surface bound initiators are known to a person skilled in the art, e.g. azo- or peroxide compounds.

The surface-bound initiators are chosen depending on the chemical structure of the solid support and the monomer to be grafted to the support.

When silica solid supports are used, the binding is typically done by using the respective silanes carrying an initiator or an activated silane for binding an initiator in a second reaction step and one suitable surface-bound initiator is tert-butyl hydroperoxide. The attachment of tert-butyl hydroperoxide and the subsequent initiation of polymerization from this initiator are described in the literature [N. Tsubokawa, H. Ishida, J.Polym. Sci. Part A-Polym. Chem. 1992, 30, 2241-2246 or W. Jiang, K. Irgum, Anal. Chem. 2002, 74, 4682-4687]. It is typically done by first activating silica with thionyl chloride and then attaching tert-butyl hydroperoxide. Grafting is done with suitable vinyl monomers.

It has been found that the best stationary phases for HILIC can be produced if polymerization is performed in solvents in which the monomers are only partially soluble. Little polymerization was seen in solvents that completely dissolved the monomer, which is contrary to the normal behavior of monomers. Without wanting to be bound to this theory, this might be rationalized by the formation of micellar structures, in which the vinyl groups to be attacked by the radical are shielded against the polar solvent by the hydroxyl groups of the hydrophilic residue, thus making it virtually impossible to initiate the polymerization. In contrast to this, solvents that did not dissolve the monomers completely caused a phase separation, and it appeared as if the phase boundary between solvent and the monomers resulted in exposure of the hydrophobic double bond towards the nonpolar phase, making it available for radical polymerization.

As a consequence, in a preferred embodiment of the present invention, polymerization of the monomers to the solid support is performed in solvents in which the monomers is only partially soluble. The choice of the solvent is dependent on the monomer used. As a consequence, the person skilled in the art typically has to do a few experiments to find out the most suitable solvent. In general, most typically, a mixture of two or more solvents is used. Suitable solvents are dichloromethane, diethylether, acetonitrile, n-heptane, 2-octanol, toluene, ethylacetate or mixtures thereof. Most preferred is the use of toluene and ethyl acetate in toluene:ethylacetat ratios between 1:5 and 10:1 (v:v), preferably between 1:2 and 5:1, most preferred between 1:1 and 3:1.

Preferably, the polymerization of the neutral hydrophilic vinyl monomers to the solid support is done quite slow, that means an initiator is used that is suitable to do a slow initiation process so that the whole polymerization reaction takes 1 to 20 hours, typically between 3 and 8 hours. If a thermally decomposable initiator is used, temperature is preferably risen slow and moderate, to slowly decompose the initiator.

Beside the use of the a solid support onto which neutral hydrophilic vinyl monomers have been graft-polymerized according to the methods described above, for hydrophilic interaction chromatography (HILIC), the present invention is also directed to a method for separating at least two analytes by HILIC using the said solid support and to solid phase extraction.

That means the present invention is directed to a chromatographic separation by HILIC. A person skilled in the art knows how to do a chromatographic separation. The solid phase is typically packed in separation columns, capillaries or cartridges. The distinct features of such cartridges, capillaries or columns are dependent on the features of the solid phase. Particulate materials are typically packed into column-, capillary- or cartridge tubes and are retained by frits. Monolithic solid phases are cladded with liquid-tights wrappings, e.g. made of organic polymers or are produced in situ in suitable columns, cartridges or capillaries.

In solid phase extraction, the solid support onto which neutral hydrophilic vinyl monomers have been graft-polymerized according to the methods described above, are used to extract analytes from mixtures or probes. For this application, the solid phase according to the present invention is typically incorporated in dip-sticks, needles, capillaries or other instruments suitable for solid phase extraction or solid phase microextraction.

The materials and the method according to the present invention are especially useful for the separation of polyvalent, e.g. polycationic or polyanionic, compounds like aminosugars or ATP.

Without further elaboration, it is believed that one skilled in the art can, using the preceding description, utilise the present invention to its fullest extent. The preferred specific embodiments and examples are, therefore, to be construed as merely illustrative, and not limiting to the remainder of the disclosure in any way whatsoever.

The entire disclosures of all applications, patents, and publications cited above and below are hereby incorporated by reference.

### EXAMPLES

Reagents and Chemicals. Kromasil spherical silica particles (5 μm particle; 200 Å pore size) were from Chemicals (Bohus, Sweden). The sorbitol methacrylate monomer was from Monomer-Polymer Labs (Feasterville, Pa., USA) and was used as received. tert-Butyl hydroperoxide (5 M in n-decane), was purchased from Sigma-Aldrich (Schnelldorf, Germany), and diethyl ether, n-heptane, 2-propanol, and thionyl chloride (99.6%) was obtained from Merck KGaA(Darmstadt, Germany). Toluene, chloroform, and methanol (all of analytical or “HPLC grade”) were from Fisher Scientific (Pittsburgh, Pa., USA), 1,4-dioxane from Scharlau (Barcelona, Spain), and acetonitril, THF, and DMF were from J. T. Baker (Phillipsburg, N.J., USA). The ethyl acetate was from Lab Scan (Stillorgan, Dublin, Ireland).

Test Polymerizations. Polymerization tests are conducted in 3 ml vials with screw caps charged with 1.5 ml solvent and 0.5 ml monomer. The vials are closed, vortexed, and briefly sonicated in a Branson (Bransonic, Danbury, Conn., USA) model 3510 ultrasonic bath to effectively homogenize the solvent and monomer. Absence of visible precipitate or phase separation is taken as an indication that the monomer is soluble. One drop of tert-butyl hydroperoxide is then added, and a control, without tert-butyl hydroperoxide but with the same solvent and monomer, is prepared to ascertain that spontaneous polymerization does not occur. The vials are mounted on a custom made tumbling device, which turns the vials end-over-end at a speed of 15 rpm, and polymerization takes place in a convection oven at 80° C. for 18 h. The viscosity and transparency of the polymerization mixture is used as a “quick and dirty” test to evaluate if polymerization has occurred.

Chlorination. Chlorination of silica is done according to literature [W. Jiang, K. Irgum, Anal. Chem. 2002, 74, 4682-4687. or N. Frey, R. Laible, K. Hamann, Angew. Makromol. Chem. 1973, 34, 81-109.]. A 2 g aliquot of Kromasil silica particles is transferred to a round bottom flask, charged with 40 ml thionyl chloride (NOTE: Thionyl chloride is extremely reactive and corrosive, and should be handled with the outmost care) and 40 ml chloroform, fitted with a reflux condenser. The chlorination of the silica takes place at 80° C. for 18 h under slow stirring and reflux. The suspension is allowed to cool to room temperature, filtered through a glass filter, and washed with aliquots of chloroform (total ˜50 mL) to remove excess thionyl chloride.

Peroxidation. While still wet by chloroform, the silica slurry is transferred to a 100 mL E-flask charged with 17 ml 5 M tert-butyl hydroperoxide in n-decane and 0.25 g of solid sodium bicarbonate in 60 ml 1,4-dioxane. The flask is wrapped in aluminum foil and placed on an orbital shaker at room temperature for 18 h. The tert-butylperoxidated silica is washed with 50 ml of methanol through a glass filter and dried under partial vacuum at room temperature.

Graft Polymerization of Sorbitol Methacrylate. The dry peroxidated silica is transferred to a round bottom flask fitted with a reflux condenser, charged with 0.8 ml sorbitol methacrylate in a solvent mixture consisting of 10 ml toluene and 5 ml ethyl acetate, and reacted with stirring at 80° C. for 18 h under N₂ gas with reflux. The grafted silica particles are washed with sonication in water/1-propanol 70/30% (v/v), centrifuged, and the supernatant is discarded. This washing step is repeated four times. The remaining pellet is collected and washed one last time with methanol before it was dried under partial vacuum.

Characterization. A small amount of dried grafted particles is ground with KBr (weight ratio approx. 1:50 to 1:100) in a mortar to a homogeneous fine powder. FT-IR spectra were collected in diffuse reflectance mode on a Burker Equinox 55 (Ettlingen, Germany) FT-IR spectrometer fitted with a DRA-2Cl cell from Harrick Scientific (Pleasantville, N.Y.). The background (pure KBr) and the sample signal are collected for 128 scans between 5,200 and 400 cm⁻¹.

The success of the grafting is evident from the IR spectra in FIG. 1, where new peaks from a C═O stretch at 1700 cm⁻¹ and a CH₃ stretch at 3000 cm⁻¹ emerge in the SMA grafted silica. The increased absorbance in the —OH region around 3400 cm⁻¹ is attributed to the five hydroxyl groups of each sorbitol methacrylate, adding to the hydroxyls from the free silanol groups present on the silica substrate.

The amount of grafting is quantified by carbon elemental analysis. Elemental analysis is conducted by Pracowina Analityczna, Warsaw, Poland, and at least duplicate measurements are done. A carbon content of 7.7% is found, which corresponds to 16% sorbitol methacrylate polymer on the stationary phase. This is approximately the same carbon loading as on commercial C₁₈ reversed phases, and seems like a reasonable amount of grafting for a HILIC phase which is intended to act as a swollen layer analogous to the reverse phase alkyl chains. The pore system should thus be accessible to a similar extent as in a typical reversed phase silica.

Column Packing. Silica with polymerized sorbitol methacrylate is wetted with methanol to form a slurry, which is sonicated for 30 minutes to eliminate air, and to ascertain homogenization. The particles are then packed from methanol in a 100 mm long by 2.1 mm i.d. PEEK column (Isolation Technologies, Hopedale, Mass.), using a DSTV-122 air driven fluid pump from Haskel Engineering and Supply (Burbank, Calif., USA) with a pneumatic amplifier ratio of 122:1, operated at a packing pressure of 30 MPa.

Evaluation of the Sorbitol Methacrylate Stationary Phase. The pumps and autosampler used are from a Hewlett Packard (currently Agilent; Palo Alto, Calif.) Series 1050 HPLC system. The sample injection volume is 5 μL. A Spectra (Thermo Scientific; Waltham, Mass.) model 100 UV absorbance detector operated at 254 nm is connected to a PC computer equipped with Clarity Chromatography Station for Windows 2.3.0.148 from Data Apex (Prague, Czech Republic) for data acquisition. The eluents used are 70:30 (v/v) mixtures of acetonitrile with aqueous ammonium formate at 25 mM concentration, at pH 4.0.

Before tests commence, the systems are equilibrated until a straight baseline is obtained. A flow rate of 0.15 ml/min is used for the SMA (100×2.1 mm) and Kromasil silica (150×2.1 mm) columns (both packed in house), whereas the two commercial reference columns ZIC-HILIC (SeQuant, Umeå, Sweden) and Atlantis HILIC (Waters, Milford, Mass., USA) are 100×4.6 mm and operated at 0.72 ml/min flow rate, so that the linear flow rates should be identical in all cases. A blank (eluent) is injected to check the system setup.

A test mixture consisting of toluene, uracil, and cytosine (4-amino-3H-pyrimidin-2-one) dissolved in eluent is injected on all four columns (the sorbitol methacrylate silica and the three references) to evaluate the chromatographic characteristics of our new stationary phase.

Chromatograms from four tested columns, the SMA grafted silica and the three reference columns, are shown in FIG. 2. When separation efficiencies are compared, one has to bear in mind that the SMA and Kromasil silica columns are 2.1 mm, whereas the two commercial columns are 4.6 mm. The capacity factor (k′) calculated for each peak, column and eluent composition are shown in Table 2, using toluene as tₘ marker.

TABLE 2
Retention factors for uracil and cytosine on the SMA silica and
three other HILIC phases.

| | Uracil | Cytosine |
|---|---|---|
| Column | 25 mM | 25 mM |
| SMA grafted | 0.45 | 1.54 |
| silica | | |
| ZIC HILIC | 0.39 | 0.94 |
| Waters Atlantis | 0.31 | 0.77 |
| Unmodified | 0.18 | 0.45 |
| silica | | |

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Use of a sorbent comprising a solid support onto which neutral hydrophilic vinyl monomers have been graft-polymerized, for hydrophilic interaction chromatography (HILIC).

2. Use according to claim 1, characterized in that the neutral hydrophilic vinyl monomers comprise glycerol-, poly(ethyleneglycol)-, 2-hydroxypropyl-, sugar- and/or polyole residues.

3. Use according to claim 1, characterized in that the neutral hydrophilic vinyl monomers comprise sorbitol, mannitol, xylite, lactate.

4. Use according to claim 1, characterized in that the monomers comprise methacrylate.

5. Use according to claim 1, characterized in that the monomers are chosen from the following list of monomers:
glycerol monomethacrylate
poly(ethylene glycol)monomethylether monomethacrylate
poly(ethylene glycol)monomethacrylate
N-(2-hydroxypropyl)methacryl amide
Erythrose methacrylate
Threose methacrylate
Ribose methacrylate
Arabinose methacrylate
Xylose methacrylate
Lyxose methacrylate
Ribulose methacrylate
Xylulose methacrylate
Allose methacrylate
Altrose methacrylate
Glucose methacrylate
Mannose methacrylate
Gulose methacrylate
Idose methacrylate
Galactose methacrylate
Talose methacrylate
psicose methacrylate
fructose methacrylate
sorbose methacrylate
tagatose methacrylate
Fucose methacrylate
Fuculose methacrylate
Rhamnose methacrylate
Erythrose acrylate
Threose acrylate
Ribose acrylate
Arabinose acrylate
Xylose acrylate
Lyxose acrylate
Ribulose acrylate
Xylulose acrylate
Allose acrylate
Altrose acrylate
Glucose acrylate
Mannose acrylate
Gulose acrylate
Idose acrylate
Galactose acrylate
Talose acrylate
psicose acrylate
fructose acrylate
sorbose acrylate
tagatose acrylate
Fucose acrylate
Fuculose acrylate
Rhamnose acrylate
Erythrose acrylamide
Threose acrylamide
Ribose acrylamide
Arabinose acrylamide
Xylose acrylamide
Lyxose acrylamide
Ribulose acrylamide
Xylulose acrylamide
Allose acrylamide
Altrose acrylamide
Glucose acrylamide
Mannose acrylamide
Gulose acrylamide
Idose acrylamide
Galactose acrylamide
Talose acrylamide
psicose acrylamide
fructose acrylamide
sorbose acrylamide
tagatose acrylamide
Fucose acrylamide
Fuculose acrylamide
Rhamnose acrylamide
Erythrose methacrylamide
Threose methacrylamide
Ribose methacrylamide
Arabinose methacrylamide
Xylose methacrylamide
Lyxose methacrylamide
Ribulose methacrylamide
Xylulose methacrylamide
Allose methacrylamide
Altrose methacrylamide
Glucose methacrylamide
Mannose methacrylamide
Gulose methacrylamide
Idose methacrylamide
Galactose methacrylamide
Talose methacrylamide
psicose methacrylamide
fructose methacrylamide
sorbose methacrylamide
tagatose methacrylamide
Fucose methacrylamide
Fuculose methacrylamide
Rhamnose methacrylamide
Sorbitol Acrylamide
Sorbitol Methacrylamide
Mannitol Acrylamide
Mannitol Methacrylamide
Xylitol Acrylamide
Xylitol Methacrylamide
Erythritol Acrylamide
Erythritol Methacrylamide
Maltitol Acrylamide
Maltitol Methacrylamide
Lactitol Acrylamide
Lactitol Methacrylamide
Threitol Acrylamide
Threitol Methacrylamide
Abitol Acrylate
Abitol Methacrylate
Abitol acrylamide
Abitol Methacrylamide
Sorbitol Acrylate
Sorbitol Methacrylate
Mannitol Acrylate
Mannitol Methacrylate
Xylitol Acrylate
Xylitol Methacrylate
Erythritol Acrylate
Erythritol Methacrylate
Maltitol Acrylate
Maltitol Methacrylate
Lactitol Acrylate
Lactitol Methacrylate
Threitol Acrylate
Threitol Methacrylate.

6. Use according to claim 1, characterized in that the solid support is made of particulate or monolithic silica.

7. Use according to claim 1, characterized in that the neutral hydrophilic monomers have been graft-polymerized to the solid support by a grafting-from process.

8. Use according to claim 1, characterized in that the neutral hydrophilic monomers have been graft-polymerized to the solid support by a grafting-from process using a surface-bound initiator.

9. Method for separating at least two analytes by hydrophilic interaction chromatography characterized in that a sorbent is used which comprises a solid support onto which neutral hydrophilic monomers have been graft-polymerized.

10. Method according to claim 9, characterized in that a sorbent is used which comprises a solid support onto which neutral hydrophilic monomers have been graft-polymerized via a grafting-from process.

11. Method according to claim 9, characterized in that a sorbent is used which comprises a solid support onto which neutral hydrophilic monomers have been graft-polymerized which comprise sugar- and/or polyole residues.
